(19) United States
(12) Patent Application Publication
(10) Pub. No.: US 2016/0125325 A1
(43) Pub. Date: May 5, 2016

(54) SEARCH RECOMMENDATION METHOD AND APPARATUS

(71) Applicant: BAIDU ONLINE NETWORK TECHNOLOGY (BEIJING) CO., LTD., Beijing (CN)

(72) Inventors: Jizhou HUANG, Beijing (CN); Minghua ZHAO, Beijing (CN); Haifeng WANG, Beijing (CN)

(21) Appl. No.: 14/897,961

(22) PCT Filed: Oct. 24, 2014
(86) PCT No.: PCT/CN2014/089501

§ 371 Date: Dec. 11, 2015

(30) Foreign Application Priority Data
Mar. 21, 2014 (CN) 201410109349.9

(51) Int. Cl. G06Q 10/02; G06Q 30/06; G06Q 50/12; G06F 17/30

(52) U.S. Cl. CPC G06Q 10/02; G06F 17/30864; G06F 17/30554; G06Q 30/0625; G06Q 30/0631; G06Q 50/12

(57) ABSTRACT

Provided are a method and a device for search recommendations, the method comprising: reception of a search term inputted by a user, acquisition of a plurality of search results related to the search term, and further acquisition of at least one merchant order form interface related to said search term; provision of a search page whereupon are further provided a plurality of search results and order form pages generated according to the order form interfaces. The search and recommendation method provided in the embodiments of the present invention obtain, on the basis of received user-inputted search terms and subsequent search, a plurality of search results related to the search terms and at least one merchant order form interface related to such search terms, thus providing users with swift and convenient order-form services, satisfying user requirements and improving user experience.

### CROSS-REFERENCE TO RELATED APPLICATION

This application claims priority to Chinese Patent Application Serial No. 201410109349.9, titled “Search Recommendation Method and Apparatus” filed by Baidu Online Network Technology (Beijing) Co., Ltd on Mar. 21, 2014.

### FIELD

Embodiments of the present invention generally relate to a field of computer networking technology, and more particularly to a search recommendation method and a search recommendation apparatus.

### BACKGROUND

With the constant development of computer technology, the application of Internet becomes more and more popular, and the users thereof can obtain desired network resources via a search engine.

Currently, the user needs to input a search term when searching for commodity information by the search engine, then obtains information on a relevant merchant, and finally enters an order page of the merchant to conduct an operation of ordering commodities, for example, telephone ordering or online ordering.

However, the inventor finds some problems in the prior art during realizing the present invention. The above method in the prior art is complex, inconvenient and inefficient to operate, resulting in poor user experience.

### SUMMARY

Embodiments of the present invention seek to solve the above technical problems to at least some extent.

Accordingly, a first objective of the present invention is to provide a search recommendation method which is able to provide the user with convenient and efficient ordering service to satisfy user requirements and improve user experience.

A second objective of the present invention is to provide a search recommendation apparatus.

A third objective of the present invention is to provide a storage medium.

In order to achieve above objectives, embodiments of a first aspect of the present invention provide a search recommendation method. The search recommendation method includes: receiving a search term input by a user; obtaining a plurality of search results related to the search term, and further obtaining an order interface of at least one merchant related to the search term; providing a search page, and providing the plurality of search results and an order page generated according to the order interface in the search page.

By receiving the search term input by the user and searching with the search term, obtaining a plurality of search results related to the search term and an order interface of at least one merchant related to the search term, the search recommendation method according to embodiments of the present invention provides the user with convenient and efficient ordering service, so as satisfy user requirements and improve user experience.

Embodiments of a second aspect of the present invention provide a search recommendation apparatus. The search recommendation apparatus includes: a receiving module configured to receive a search term input by a user; an obtaining module configured to obtain a plurality of search results related to the search term, and to further obtain an order interface of at least one merchant related to the search term; and a providing module configured to provide a search page, and to provide the plurality of search results and an order page generated according to the order interface in the search page.

By receiving the search term input by the user and searching with the search term, obtaining a plurality of search results related to the search term and an order interface of at least one merchant related to the search term, the search recommendation apparatus according to embodiments of the present invention provides the user with convenient and efficient ordering service, so as satisfy user requirements and improve user experience.

In order to achieve above objectives, embodiments of a third aspect of the present invention provide a storage medium for storing an application program which is configured to execute the search recommendation method according to the embodiments of the first aspect of the present invention.

Additional aspects and advantages of embodiments of the present invention will be given in part in the following descriptions, become apparent in part from the following descriptions, or be learned from the practice of the embodiments of the present invention.

### BRIEF DESCRIPTION OF THE DRAWINGS

These and other aspects and advantages of embodiments of the present invention will become apparent and more readily appreciated from the following descriptions made with reference to the drawings, in which:

FIG. 1a is a flow chart of a search recommendation method according to an embodiment of the present invention;

FIG. 1b is a schematic diagram showing a rendering of a search page;

FIG. 1c is a schematic diagram showing a rendering of a second display section;

FIG. 2 is a flow chart of a search recommendation method according to another embodiment of the present invention;

FIG. 3 is a flow chart of a search recommendation method according to another embodiment of the present invention;

FIG. 4 is a block diagram of a search recommendation apparatus according to an embodiment of the present invention;

FIG. 5 is a block diagram of a search recommendation apparatus according to another embodiment of the present invention; and

FIG. 6 is a block diagram of a search recommendation apparatus according to another embodiment of the present invention.

### DETAILED DESCRIPTION

Embodiments of the present invention will be described in detail and examples of the embodiments will be illustrated in the drawings, wherein same or similar reference numerals are used to indicate same or similar members or members with same or similar functions. The embodiments described herein with reference to drawings are explanatory, which are used to illustrate the present invention, but shall not be construed to limit the present invention.

A search recommendation method and a search recommendation apparatus according to embodiments of the present invention will be described in the following with reference to drawings.

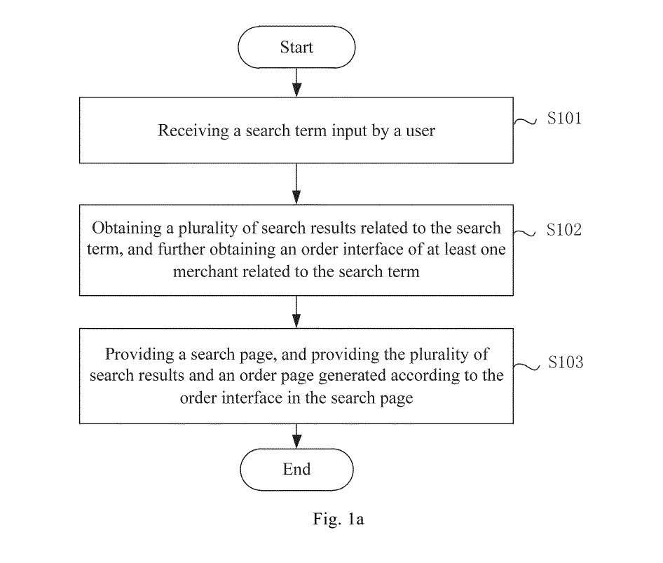

FIG. 1a is a flow chart of a search recommendation method according to an embodiment of the present invention. As shown in FIG. 1a, the search recommendation method includes the following steps.

In step 101: a search term input by a user is received.

In the embodiment of the present invention, the user may input the search term in a search bar provided by a search engine. For example, the user may input a food vocabulary, such as “roast duck,” “buns” and “noodles,” or input a commodity vocabulary, such as “shirts,” “suits” and “leather shoes.”

In step 102: a plurality of search results related to the search term is obtained, and an order interface of at least one merchant related to the search term is further obtained.

In the embodiment of the present invention, the search engine may obtain information related to the search term from the Internet according to the search term via a search strategy, and obtain a plurality of search results related to the search term after organizing and processing the information. The expression “a plurality of” described in this embodiment means two or more than two. Different from the current search engine, the search engine in the embodiment of the present invention may further determine whether the search term satisfies a preset order operation requirement after obtaining the plurality of search results related to the search term. For example, if the search term is a location name, such as “Beijing” and “Shanghai”, it is impossible to satisfy the preset order operation requirement. If the search term is a noun capable of forming a demand, such as “roast duck” and “dishes over rice”, the preset order operation requirement is satisfied and the user may perform an ordering operation. If the search term satisfies the preset order operation requirement, the search engine may further obtain an order interface of at least one merchant related to the search term. For example, the search engine may know that some merchants, like “Quanjude” and “Bianyifang”, are accessible for online order according to the search term “roast duck”, and then obtain order interfaces of the above merchants, such that the user can order online via the order interfaces.

In step 103: a search page is provided, and the plurality of search results and an order page generated according to the order interface are provided in the search page.

In the embodiment of the present invention, the search engine provides the user with a search page after the order interface of the at least one merchant related to the search term is obtained. The search page includes a first display section and a second display section, in which the first display section contains the plurality of search results, and the second display section contains the order page of the at least one merchant generated according to the order interface. For instance, if the user inputs a search term “roast ducks”, the search result related to “roast ducks” is displayed at the left half of the search page (i.e. the first display section) after the search conducted by the search engine. The right half of the search page (i.e. the second display section) displays an order page of “Quanjude”. The first display section and the second display section are shown in FIG. 1b; the second display section is shown in FIG. 1c. The user may directly input corresponding information in the order page of “Quanjude” to make a reservation with “Quanjude”.

By receiving the search term input by the user and searching with the search term, obtaining a plurality of search results related to the search term and an order page of at least one merchant related to the search term, the search recommendation method according to embodiments of the present invention provides the user with convenient and efficient ordering service, so as satisfy user requirements and improve user experience.

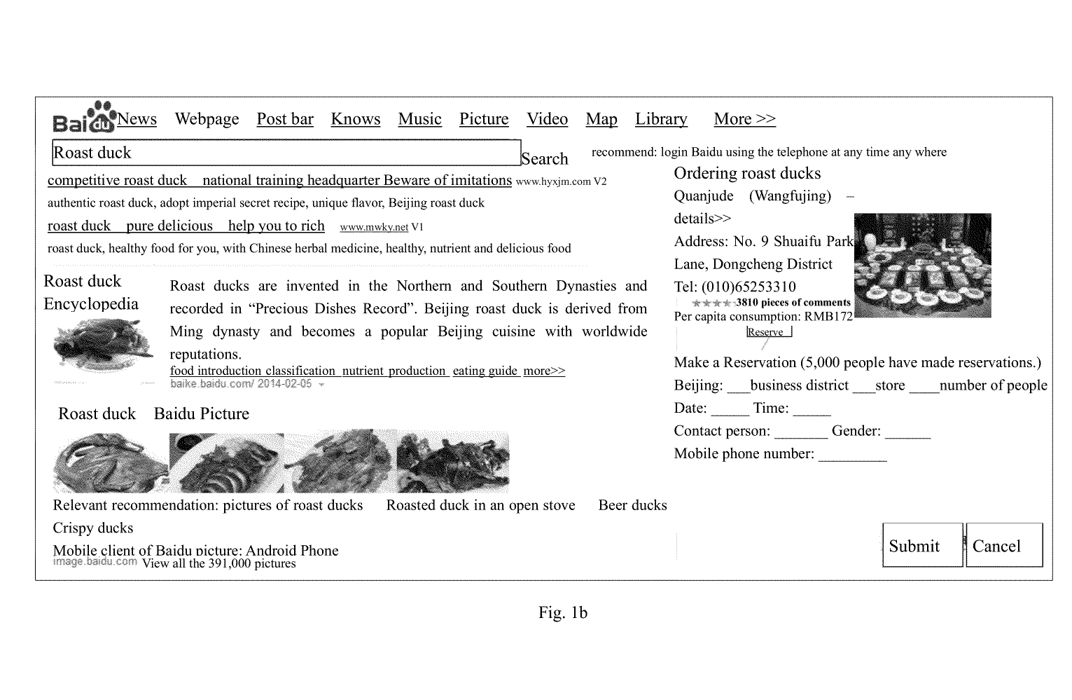

FIG. 2 is a flow chart of a search recommendation method according to another embodiment of the present invention. As shown in FIG. 2, the search recommendation method includes the following steps.

In step 201: a search term input by a user is received.

In the embodiment of the present invention, the user may input the search term in a search bar provided by a search engine. For example, the user may input a food vocabulary, such as “roast duck,” “buns” and “noodles,” or input a commodity vocabulary, such as “shirts,” “suits” and “leather shoes.”

In step 202: a plurality of search results related to the search term is obtained, and an order interface of at least one merchant related to the search term is further obtained.

In the embodiment of the present invention, the search engine may obtain information related to the search term from the Internet according to the search term via a search strategy of the search engine, and obtain a plurality of search results related to the search term after organizing and processing the information. The expression “a plurality of” described in this embodiment means two or more than two. Different from the current search engine, the search engine in the embodiment of the present invention may further determine whether the search term satisfies a preset order operation requirement after obtaining the plurality of search results related to the search term. For example, if the search term is a location name, such as “Beijing” and “Shanghai”, it is impossible to satisfy the preset order operation requirement. If the search term is a noun capable of forming a demand, such as “roast duck” and “dishes over rice”, the preset order operation requirement is satisfied and the user may perform an ordering operation.

If the search term satisfies the preset order operation requirement, the search engine may further obtain an order interface of at least one merchant related to the search term. For example, the search engine may know that some merchants, like “Quanjude” and “Bianyifang”, are accessible for online order according to the search term “roast duck”, and then obtain order interfaces of the above merchants, such that the user can order online via the order interfaces.

In step 203: a search page is provided, and the plurality of search results and an order page generated according to the order interface are provided in the search page.

In the embodiment of the present invention, the search engine provides the user with a search page after the order interface of at least one merchant related to the search term is obtained. The search page includes a first display section and a second display section, in which the first display section contains the plurality of search results, and the second display section contains the order page of the at least one merchant generated according to the order interface. For instance, if the user inputs a search term “roast ducks”, the search result related to “roast ducks” is displayed at the left half of the search page (i.e. the first display section) after the search conducted by the search engine. The right half of the search page (i.e. the second display section) displays an order page of “Quanjude”. The user may directly input corresponding information in the order page of “Quanjude” to make a reservation with “Quanjude”.

In step 204, order information input in the order page by the user is received and a reservation is made with the at least one merchant.

In the embodiment of the present invention, the search engine may receive the order information input in the order page by the user, and make a reservation with the corresponding merchant. For example, the user may input name, contact number, number of people having dinner and reservation time to complete the reservation with “Quanjude”.

With the search recommendation method according to embodiments of the present invention, the user may directly make a reservation with the corresponding merchant at the second display section of the search page in a convenient and efficient manner by receiving the search term input by the user and conducting the search with the search term, obtaining a plurality of search results related to the search term and an order interface of at least one merchant related to the search term, which further satisfies user requirements and improves user experience.

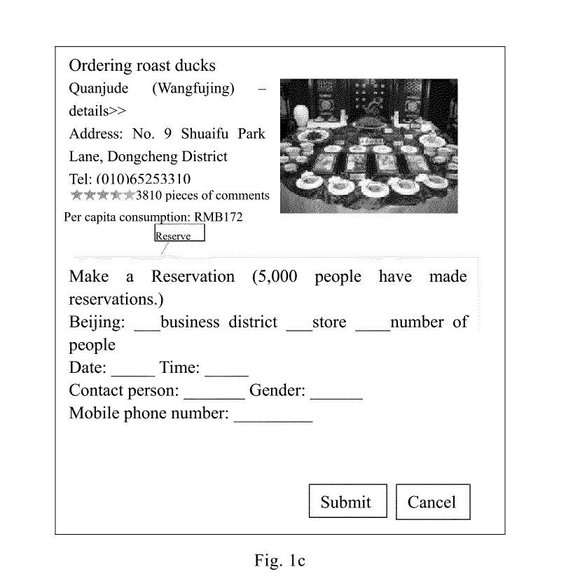

FIG. 3 is a flow chart of a search recommendation method according to another embodiment of the present invention. As shown in FIG. 3, the method includes the following steps.

In step 301: a search term input by a user is received.

In the embodiment of the present invention, the user may input the search term in a search bar provided by a search engine. For example, the user may input a food vocabulary, such as “roast duck,” “buns” and “noodles,” or input a commodity vocabulary, such as “shirts,” “suits” and “leather shoes.”

In step 302: a plurality of search results related to the search term is obtained, and an order interface of at least one merchant related to the search term is further obtained.

In the embodiment of the present invention, the search engine may obtain information related to the search term from the Internet according to the search term via a search strategy of the search engine, and obtain a plurality of search results related to the search term after organizing and processing the information. The expression “a plurality of” described in this embodiment means two or more than two. Different from the current search engine, the search engine in the embodiment of the present invention may further determine whether the search term satisfies a preset order operation requirement after obtaining the plurality of search results related to the search term. For example, if the search term is a location name, such as “Beijing” and “Shanghai”, it is impossible to satisfy the preset order operation requirement. If the search term is a noun capable of forming a demand, such as “roast duck” and “dishes over rice”, the preset order operation requirement is satisfied and the user may perform an ordering operation.

If the search term satisfies the preset order operation requirement, the search engine may further obtain an order interface of at least one merchant related to the search term. For example, the search engine may know that some merchants, like “Quanjude” and “Bianyifang”, are accessible for online order according to the search term “roast duck”, and then obtain order interfaces of the above merchants, such that the user can order online via the order interfaces.

In step 303: a search page is provided, and the plurality of search results and an order page generated according to the order interface are provided in the search page.

In the embodiment of the present invention, the search engine provides the user with a search page after the order interface of at least one merchant related to the search term is obtained. The search page includes a first display section and a second display section, in which the first display section contains the plurality of search results, and the second display section contains the order page of the at least one merchant generated according to the order interface. For instance, if the user inputs a search term “roast ducks”, the search result related to “roast ducks” is displayed at the left half of the search page (i.e. the first display section) after the search conducted by the search engine. The right half of the search page (i.e. the second display section) displays an order page of “Quanjude”. The user may directly input corresponding information in the order page of “Quanjude” to make a reservation with “Quanjude”.

In step 304, geographical location information of the at least one merchant and current position information of the user are displayed in the second display section.

In the embodiment of the present invention, the search engine may further display the geographical location information of the at least one merchant and the current position information of the user in the second display section, apart from the search result and the order page of the merchant displayed. For example, if the user inputs a search term “roast ducks”, the search result related to “roast ducks” is displayed at the left half of the search page (i.e. the first display section) after the search engine conducts the search. The right half of the search page (i.e. the second display section) may display the geographical location information of the merchant related to “roast ducks”.

In step 305, a navigation path is generated according to the geographical location information of the at least one merchant and the current position information of the user, and is displayed in the second display section.

In the embodiment of the present invention, if the user chooses one of the merchants as the destination, the search engine may generate a navigation path according to the geographical location information of the merchant and the current position information of the user, and display the navigation path in the second display section, such that the user may drive according to the navigation path.

In step 306, evaluation information about each merchant is obtained and displayed in the second display section.

In the embodiment of the present invention, the search engine may further obtain the evaluation information about each merchant and display the evaluation information in the second display section, apart from the search result and the order page of the merchant displayed. For example, if the user inputs a search term “roast ducks”, the search result related to “roast ducks” is displayed at the left half of the search page (i.e. the first display section) after the search engine conducts the search. The right half of the search page (i.e. the second display section) may display the evaluation information about the merchants related to “roast ducks,” such as taste, environment and service.

By displaying the geographical location information of the at least one merchant and the current position information of the user in the second display section, generating a navigation path, and displaying the evaluation information about each merchant in the second display section, the search recommendation method according to embodiments of the present invention provides the user with more services, which enriches the search results and improves user experience.

To realize the above embodiments, the present invention further provides a search recommendation apparatus.

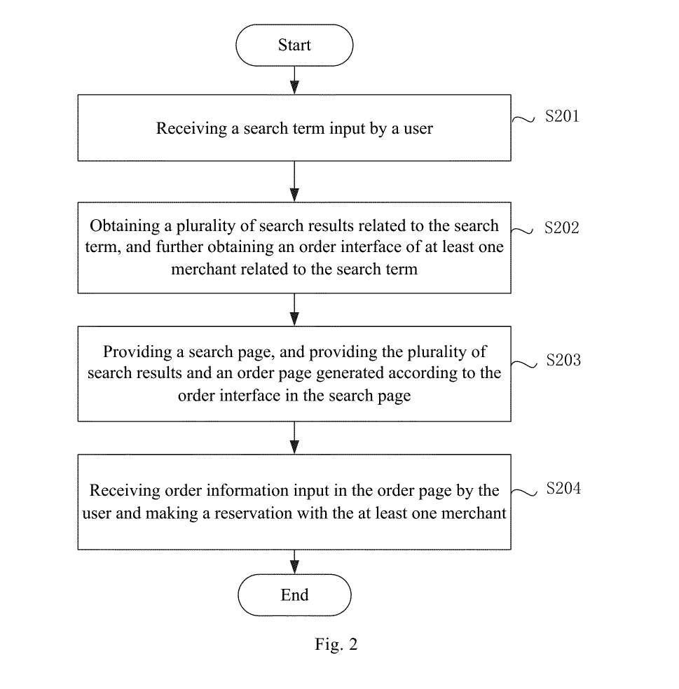

FIG. 4 is a block diagram of a search recommendation apparatus according to an embodiment of the present invention. As shown in FIG. 4, the search recommendation apparatus includes: a receiving module 100, an obtaining module 200 and a providing module 300.

Specifically, the receiving module 100 is configured to receive a search term input by a user.

In the embodiment of the present invention, the user may input the search term in a search bar provided by a search engine. For example, the user may input a food vocabulary, such as “roast duck,” “buns” and “noodles,” or input a commodity vocabulary, such as “shirts,” “suits” and “leather shoes”.

The obtaining module 200 is configured to obtain a plurality of search results related to the search term, and to further obtain an order interface of at least one merchant related to the search term.

In the embodiment of the present invention, the obtaining module 200 may obtain information related to the search term from the Internet according to the search term via a search strategy of the search engine, and obtain a plurality of search results related to the search term after organizing and processing the information. The expression “a plurality of” described in this embodiment means two or more than two. Specifically, the obtaining module 200 may further determine whether the search term satisfies a preset order operation requirement after obtaining the plurality of search results related to the search term. For example, if the search term is a location name, such as “Beijing” and “Shanghai”, it is impossible to satisfy the preset order operation requirement. If the search term is a noun capable of forming a demand, such as “roast duck” and “dishes over rice”, the preset order operation requirement is satisfied and the user may perform an ordering operation.

If the search term satisfies the preset order operation requirement, the obtaining module 200 may further obtain an order interface of at least one merchant related to the search term. For example, the search engine may know that some merchants, like “Quanjude” and “Bianyifang”, are accessible for online order according to the search term “roast duck”, and then the obtaining module 200 may further obtain order interfaces of the above merchants, such that the user can order online via the order interfaces.

The providing module 300 is configured to provide a search page, and to provide the plurality of search results and an order page generated according to the order interface in the search page.

In the embodiment of the present invention, the providing module 300 provides the user with a search page after the order interface of at least one merchant related to the search term is obtained. The search page includes a first display section and a second display section, in which the first display section contains the plurality of search results, and the second display section contains the order page of the at least one merchant generated according to the order interface. For instance, if the user inputs a search term “roast ducks”, the search result related to “roast ducks” is displayed at the left half of the search page (i.e. the first display section) after the search conducted by the search engine. The right half of the search page (i.e. the second display section) displays an order page of “Quanjude”. The user may directly input corresponding information in the order page of “Quanjude” to make a reservation with “Quanjude”.

By receiving the search term input by the user and conducting the search with the search term, obtaining a plurality of search results related to the search term and an order page of at least one merchant related to the search term, the search recommendation apparatus according to embodiments of the present invention provides the user with convenient and efficient ordering service, so as satisfy user requirements and improve user experience.

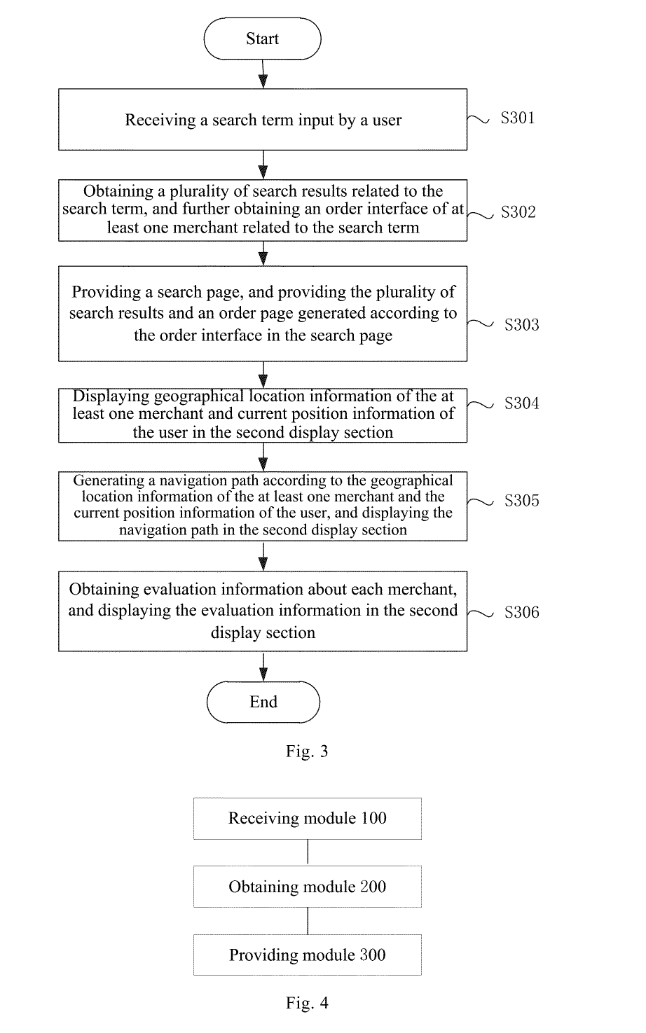

FIG. 5 is a block diagram of a search recommendation apparatus according to another embodiment of the present invention. As shown in FIG. 5, the search recommendation apparatus includes: a receiving module 100, an obtaining module 200, a providing module 300 and a reserving module 400.

Specifically, the reserving module 400 is configured to receive order information input in the order page by the user and to make a reservation with the at least one merchant.

In the embodiment of the present invention, the reserving module 400 may receive the order information input in the order page by the user and to make a reservation with the corresponding merchant. For example, the user may input name, contact number, number of people having dinner and reservation time to complete the reservation with “Quanjude”.

With the search recommendation apparatus according to embodiments of the present invention, the user may directly make a reservation with the corresponding merchant at the second display section of the search page in a convenient and efficient manner by receiving the search term input by the user and conducting the search with the search term, obtaining a plurality of search results related to the search term and an order page of at least one merchant related to the search term, which further satisfies user requirements and improves user experience.

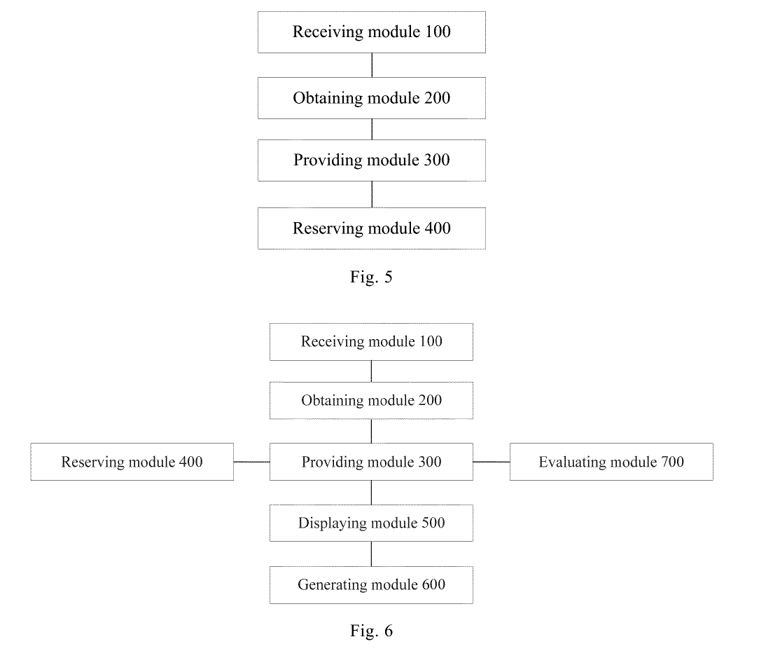

FIG. 6 is a block diagram of a search recommendation apparatus according to another embodiment of the present invention. As shown in FIG. 6, the search recommendation apparatus includes: a receiving module 100, an obtaining module 200, a providing module 300, a reserving module 400, a displaying module 500, a generating module 600 and an evaluating module 700.

Specifically, the displaying module 500 is configured to display geographical location information of the at least one merchant and current position information of the user in the second display section.

In the embodiment of the present invention, the displaying module 500 may further display the geographical location information of the at least one merchant and the current position information of the user in the second display section, apart from the search result and the order page of the merchant displayed. For example, if the user inputs a search term “roast ducks”, the search result related to “roast ducks” is displayed at the left half of the search page (i.e. the first display section) after the search engine conducts the search. The right half of the search page (i.e. the second display section) may display the geographical location information of the merchants related to “roast ducks”.

The generating module 600 is configured to generate a navigation path according to the geographical location information of the at least one merchant and the current position information of the user, and to display the navigation path in the second display section.

In the embodiment of the present invention, if the user chooses one of the merchants as the destination, the generating module 600 may generate a navigation path according to the geographical location information of the merchant and the current position information of the user, and display the navigation path in the second display section, such that the user may drive according to the navigation path.

The evaluating module 700 is configured to obtain evaluation information about each merchant, and to display the evaluation information in the second display section.

In the embodiment of the present invention, the evaluating module 700 may further obtain the evaluation information about each merchant and display the evaluation information in the second display section, apart from the search result and the order page of the merchant displayed. For example, if the user inputs a search term “roast ducks”, the search result related to “roast ducks” is displayed at the left half of the search page (i.e. the first display section) after the search engine conducts the search. The right half of the search page (i.e. the second display section) may display the evaluation information about the merchants related to “roast ducks”, such as taste, environment and service.

By displaying the geographical location information of the at least one merchant and the current position information of the user in the second display section, generating a navigation path, and displaying the evaluation information about each merchant in the second display section, the search recommendation apparatus according to embodiments of the present invention provides the user with more services, which enriches the search results and improves user experience.

To realize the above embodiments, the present invention further provides a storage medium for storing an application program which is configured to execute the search recommendation method according to any embodiment of the present invention.

Any process or method described in a flow chart or described herein in other ways may be understood to include one or more modules, segments or portions of codes of executable instructions for achieving specific logical functions or steps in the process, and the scope of a preferred embodiment of the present invention includes other implementations, not necessarily in the sequence shown or discussed here, but probably including the almost same or reverse sequence of the involved functions, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present invention may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It would be understood by those skilled in the art that all or a part of the steps carried by the method in the above-described embodiments may be completed by relevant hardware instructed by a program. The program may be stored in a computer readable storage medium. When the program is executed, one or a combination of the steps of the method in the above-described embodiments may be completed.

In addition, individual functional units in the embodiments of the present invention may be integrated in one processing module or may be separately physically present, or two or more units may be integrated in one module. The integrated module as described above may be achieved in the form of hardware, or may be achieved in the form of a software functional module. If the integrated module is achieved in the form of a software functional module and sold or used as a separate product, the integrated module may also be stored in a computer readable storage medium.

The above-mentioned storage medium may be, but is not limited to, read-only memories, magnetic disks, or optical disks.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A search recommendation method, comprising:
receiving a search term input by a user;
obtaining a plurality of search results related to the search term, and further obtaining an order interface of at least one merchant related to the search term; and
providing a search page, and providing the plurality of search results and an order page generated according to the order interface in the search page.

2. The method according to claim 1, after obtaining the plurality of search results related to the search term and before obtaining the order interface of the at least one merchant related to the search term, further comprising:
determining that the search term satisfies a preset order operation requirement.

3. The method according to claim 1, wherein the search page comprises a first display section and a second display section, the first display section comprising the plurality of search results, and the second display section comprising the order page generated according to the order interface of the at least one merchant.

4. The method according to claim 1, further comprising:
receiving order information input in the order page by the user and making a reservation with the at least one merchant.

5. The method according to claim 3, further comprising:
displaying geographical location information of the at least one merchant and current position information of the user in the second display section.

6. The method according to claim 5, further comprising:
generating a navigation path according to the geographical location information of the at least one merchant and the current position information of the user, and displaying the navigation path in the second display section.

7. The method according to claim 3, further comprising:
obtaining evaluation information about each merchant, and displaying the evaluation information in the second display section.

8. A search recommendation apparatus, comprising:
a receiving module configured to receive a search term input by a user;
an obtaining module configured to obtain a plurality of search results related to the search term, and to further obtain an order interface of at least one merchant related to the search term; and
a providing module configured to provide a search page, and to provide the plurality of search results and an order page generated according to the order interface in the search page.

9. The apparatus according to claim 8, wherein the obtaining module is specifically configured to determine that the search term satisfies a preset order operation requirement, and configured to obtain the order interface of the at least one merchant related to the search term.

10. The apparatus according to claim 8, wherein the search page comprises a first display section and a second display section, the first display section comprising the plurality of search results, and the second display section comprising the order page generated according to the order interface of the at least one merchant.

11. The apparatus according to claim 8, further comprising:
a reserving module configured to receive order information input in the order page by the user and to make a reservation with the at least one merchant.

12. The apparatus according to claim 10, further comprising:
a displaying module configured to display geographical location information of the at least one merchant and current position information of the user in the second display section.

13. The apparatus according to claim 12, further comprising:
a generating module configured to generate a navigation path according to the geographical location information of the at least one merchant and the current position information of the user, and to display the navigation path in the second display section.

14. The apparatus according to claim 10, further comprising:
an evaluating module configured to obtain evaluation information about each merchant, and to display the evaluation information in the second display section.

15. A storage medium for storing an application program which is configured to execute the search recommendation method according to any one of claims 1 to 7.
